(19) United States
(12) Patent Application Publication
(10) Pub. No.: US 2007/0158441 A1
(43) Pub. Date: Jul. 12, 2007

(54) IDENTIFICATION DATA CARRIER, READ DEVICE, IDENTIFICATION SYSTEM AND PROCEDURE FOR MANUFACTURING AN IDENTIFICATION DATA CARRIER

(75) Inventors: Sylvain Briole, Hanau (DE); Ralf Brederlow, Poing (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/621,337

(22) Filed: Jan. 9, 2007

(30) Foreign Application Priority Data
Jan. 11, 2006 (DE) 10 2006 001 504.5

(51) Int. Cl. G06K 19/06; G06K 7/08

(52) U.S. Cl. 235/492; 235/451

(57) ABSTRACT

An identification data carrier has a substrate as well as a resonant circuit structure, which is formed on or in the substrate, for an electromagnetic resonant circuit. The resonant circuit structure has a resonant frequency which is specific for an object to be identified. A read apparatus for reading object-specific information which is contained in an identification data carrier has, an electromagnetic radiation source for emission of electromagnetic energy in a predeterminable frequency range, a detection device for detection of the electromagnetic energy which is absorbed by a resonant circuit structure of the identification data carrier at different frequencies in the frequency range, and for determination of the value of the resonant frequency of the resonant circuit structure, a determination device for determination of the object-specific information which is contained in the identification data carrier, from the value of the resonant frequency of the resonant circuit structure. An identification system has at least one identification data carrier as well as a read apparatus having the features described above. In a method for producing an identification data carrier, a resonant circuit structure for an electromagnetic resonant circuit is formed on a substrate in such a manner that it has a resonant frequency which is specific for an object to be identified.

### BACKGROUND TO THE INVENTION

The invention relates to an identification data carrier, to a read apparatus, to an identification system and to a method for producing an identification data carrier.

It is desirable to produce identification data carriers with a high data capacity on a cost-efficient basis.

### BRIEF DESCRIPTION OF THE FIGURES

In the figures:

FIG. 1 shows an identification system according to one exemplary embodiment of the invention;

FIG. 2 shows an identification system according to another exemplary embodiment of the invention;

FIG. 3 shows a power absorption spectrum according to one exemplary embodiment of the invention; and

FIG. 4 shows a resonant circuit structure of an identification data carrier according to one exemplary embodiment of the invention.

### DETAILED DESCRIPTION OF THE INVENTION

In many fields of daily life, identification marks are used to identify people or objects. Conventionally, identification marks are used, for example, based on barcodes, although these are labor-intensive and thus expensive in use, since they must be read using an optical reading apparatus, which has to be operated by a user. Furthermore, barcode systems cannot be used in a worthwhile form in many fields of application for identification marks (for example as anti-theft systems in department stores).

One alternative to barcode systems is to use radio labels (so-called transponders) as identification data carriers. In contrast to barcodes, radio labels can be read from and written to without any visual contact, and they generally also operate even when they have become dirty or their surfaces have been scratched.

At the moment, there are essentially two different types of transponder labels (also referred to as tags), which compete with barcodes:

(i) One-bit Tags

This comprises a connection from a single resonant circuit loop which comprises a coil and a capacitor, with the coil and the capacitor being arranged on a plastic carrier (for example a plastic film or plastic stick). One and only one bit (binary digit) of information can be stored in a tag such as this, with the one bit being coded by the “presence” (logic value “1”) or the “absence” (logic value “0”) of the tag in a magnetic field at a predetermined frequency in the radio-frequency (RF) range. A tag such as this is therefore also referred to as an RF tag. The absence of an RF tag is implemented by the tag being made unusable (inoperable) for example by a mechanical influence (mechanical destruction) or by the use of a very high electromagnetic field, which leads to the resonant circuit destroying itself. One-bit tags are relatively economical and are typically used to prevent shoplifting of valuable items (for example compact disks, CDs). One obvious disadvantage of these tags is, however, that only one bit can be stored in the tag. One-bit tags therefore cannot compete with barcodes, in terms of the data capacity.

(ii) RFID tags (radio frequency identification tags)

These tags comprise a silicon chip which is connected to an antenna, with the chip and the antenna being fitted to a substrate (for example to a plastic film). An RFID tag allows a greater amount of information (that is to say more bits) to be stored than a one-bit tag. However, one disadvantage is that the production price of about 10 cents (0.10 Euro) per RFID tag at the moment is too high for many markets in order to allow competition with barcodes in the respective market.

By reducing the total production costs to less than 1 cent (0.01 Euro) per tag, it will become possible to replace conventional barcodes by electronic passive barcodes, and for these electronic passive barcodes to become widespread in a large number of fields of use.

In a conventional identification data carrier, a plurality of resonant circuit structures (“antennas”) for electromagnetic resonant circuits are formed on a substrate, with the resonant circuit structures having different resonant frequencies. One disadvantage of this data carrier is the large amount of space required by the plurality of antennas.

Furthermore, it is known for information to be coded by means of amplitude modulation.

An identification data carrier according to one exemplary embodiment of the invention has a substrate as well as a resonant circuit structure, which is formed on or in the substrate, for an electromagnetic resonant circuit. The resonant circuit structure has a resonant frequency which is specific for an object to be identified.

According to another exemplary embodiment of the invention, the principle of a one-bit tag having a resonant circuit loop, with the one-bit tag being able to store only a single bit (that is to say the tag is present or absent), is extended in such a manner that this results in an identification data carrier having an electromagnetic resonant circuit, which identification data carrier can store a plurality of bits of information, and thus object-specific information, and which can nevertheless be produced easily and at low cost. For that purpose, the resonant circuit structure of the identification data carrier can be formed in such a manner that it has a resonant frequency whose value is specific for an object to be identified.

According to another exemplary embodiment of the invention, an identification data carrier is provided which combines in it an advantageous characteristic of one-bit tags, that is to say good cost efficiency, with an advantageous characteristic of barcodes, that is to say a high data capacity.

According to another exemplary embodiment of the invention, an identification data carrier is provided which can be produced at very low cost. According to one exemplary embodiment of the invention, an identification data carrier can be produced at a cost of less than 0.01 Euro, and thus represents a financially competitive alternative to barcode systems.

According to another exemplary embodiment of the invention, a read apparatus is provided for reading object-specific information which is contained in an identification data carrier. The read apparatus has an electromagnetic radiation source for emission of electromagnetic energy in a predeterminable frequency range. Furthermore, the read apparatus has a detection device for detection of the electromagnetic energy which is absorbed by a resonant circuit structure of the identification data carrier at different frequencies in the frequency range, and for determination of the value of the resonant frequency of the resonant circuit structure. In addition, the read apparatus has a determination device for determination of the object-specific information which is contained in the identification data carrier, from the value of the resonant frequency of the resonant circuit structure.

According to another exemplary embodiment of the invention, the electromagnetic radiation source is configured such that the electromagnetic radiation which is emitted from it is swept once or more through a predetermined frequency range or a predetermined frequency interval (“wobbling”), in which frequency interval the resonant frequency of at least one resonant circuit is included, which at least one resonant circuit is contained in at least one identification data carrier which interacts with the read apparatus. In other words, according to one exemplary embodiment of the invention, the radiation source can carry out a so-called frequency sweep one or more times, during which a sufficiently wide range of the frequency domain can be scanned in order to allow all possible resonant circuits and their resonant frequencies to be detected.

According to another exemplary embodiment of the invention, the detection device can be used to detect the absorption of the emitted electromagnetic energy as a function of frequency over the entire frequency interval that is scanned. In other words, according to one exemplary embodiment of the invention, the detection device is used to decide on the basis of the power which is emitted in the form of the emitted electromagnetic radiation at different frequencies, whether the frequency of the emitted electromagnetic wave corresponds to a resonant frequency of a resonant circuit in an identification data carrier.

Expressed in different words once again, according to one exemplary embodiment of the invention, at least one identification data carrier is scanned in the frequency domain, and the resonant frequency of the at least one identification data carrier is determined by evaluation of a power absorption spectrum; if the frequency of the electromagnetic radiation emitted from the electromagnetic radiation source is sufficiently close to the resonant frequency of the identification data carrier, then the electromagnetic energy is absorbed, so that the absorbed energy in the absorption spectrum which can be determined by the read apparatus is particularly high for this frequency. If the frequency of the electromagnetic radiation emitted from the electromagnetic radiation source is, in contrast, considerably below the resonant frequency or considerably above the resonant frequency, then the energy absorbed by the resonant circuit at this frequency is low. The resonant frequency can thus be identified in the absorption spectrum by a maximum or a peak in the absorbed energy.

According to another exemplary embodiment of the invention, the determination device can use the value of the resonant frequency of the resonant circuit structure of an identification data carrier, as determined by means of the detection device, to determine the information which is specific for an object.

In other words, according to one exemplary embodiment of the invention, the information which is coded by the value of the resonant frequency can be decoded again with the aid of the determination device in the read apparatus.

According to one exemplary embodiment of the invention this can be done, for example, by determining a bit sequence B={b₁, b₂, . . . , bₖ, bₖ₊₁, . . . , bₙ}, for example comprising n bits bₖ ∈ {0,1}, from the value f of the resonant frequency, which bit sequence contains or has coded in it appropriate information about the object. In other words, according to one exemplary embodiment of the invention, the determination device can associate a specific bit sequence B with a resonant frequency f, for example by calculation on the basis of a predetermined algorithm or by looking it up in a databank or an association table (lookup table), for example using an electronic data processing device (for example a computer).

In other words again, according to one exemplary embodiment of the invention, the determination device can technically provide a map g which maps a set of discrete frequency values fᵢ (fᵢ ∈ R) or alternatively a set of frequency intervals [fᵢ−Δfᵢ, fᵢ+Δfᵢ] (fᵢ, Δfᵢ ∈ R) onto a set of bit sequences Bᵢ, with the map g being unique (injective), that is to say a bit sequence Bᵢ is uniquely associated with each frequency value fᵢ or each frequency interval [fᵢ−Δfᵢ, fᵢ+Δfᵢ] with the aid of the map g.

In other words, it follows for two different resonant frequency values fᵢ≠fⱼ (where “different” in this context should be understood as meaning that the two frequency values fᵢ, fⱼ are sufficiently far apart from one another), that the bit sequences Bᵢ and Bⱼ derived from them are also different, that is to say:
fᵢ≠fⱼBᵢ=g(fᵢ)≠g(fⱼ)=Bⱼ.

An identification system according to another exemplary embodiment of the invention has at least one identification data carrier with the features described above. The identification system according to the exemplary embodiment also has a read apparatus with the features described above for reading object-specific information which is contained in the at least one identification data carrier.

According to another exemplary embodiment of the invention, the read apparatus (also referred to as a reader) or the electromagnetic radiation source of the read apparatus sends a signal in the form of an electromagnetic wave at a predetermined frequency (for example with the aid of an antenna formed in the read apparatus) in order to read object-specific information which is contained in an identification data carrier or in a plurality of identification data carriers. The electromagnetic wave is received and “modulated”, that is to say changed by an identification data carrier, to be more precise the resonant circuit structure, which can be regarded as a transponder. The read apparatus or the detection device of the read apparatus (of the reader) receives, by back-scattering, the disturbance of the magnetic field caused by the modulation, and this is used, for example, to change or modify the level of an electric current in the read apparatus. The disturbance of the magnetic field reaches a maximum when the frequency of the signal transmitted from the read apparatus is equal to the resonant frequency of the transponder. By the production of electromagnetic signals or electromagnetic waves at different frequencies, for example in the course of a frequency sweep within a predeterminable frequency interval, and by reading of the electric current induced in the read apparatus at the respective frequency, it is possible to determine accurately the resonant frequencies of the identification data carriers (to be more precise the resonant frequencies of the respective resonant circuit structures) which are within the identification area (detection range) of the read apparatus, that is to say within range of the read apparatus. The current intensity decreases as the distance between the read apparatus and the transponder increases.

In a method for producing an identification data carrier according to another exemplary embodiment of the invention, a resonant circuit structure for an electromagnetic resonant circuit is formed on a substrate, with the resonant circuit structure being formed in such a manner that it has a resonant frequency which is specific for an object to be identified.

According to another exemplary embodiment of the invention, the resonant circuit structure is formed on or in the substrate with the aid of a deposition method and/or a structuring method.

According to another exemplary embodiment of the invention, a plurality of bits are stored in an identification data carrier by the identification data carrier or the resonant circuit structure of the identification data carrier having a resonant frequency which is specific for an object to be identified. In other words, according to this exemplary embodiment, the bits or the object-specific information represented by the bits are coded by fine adjustment (tuning) of the resonant frequency.

According to another exemplary embodiment of the invention, the substrate of the identification data carrier is a plastic carrier.

According to another exemplary embodiment of the invention, the substrate of the identification data carrier is the package of the object to be identified.

According to another exemplary embodiment of the invention, the resonant circuit structure of the identification data carrier has at least one capacitance and at least one inductance.

According to another exemplary embodiment of the invention, the at least one capacitance of the identification data carrier is connected in series with the at least one inductance in the identification data carrier.

According to another exemplary embodiment of the invention, at least one of the at least one capacitance in the identification data carrier is a capacitor. A capacitance in the form of a capacitor can clearly form a coupling capacitor in the resonant circuit.

According to another exemplary embodiment of the invention, at least one of the at least one inductance in the identification data carrier is an induction coil. An inductance in the form of an induction coil can clearly form a coupling coil for the resonant circuit.

According to another exemplary embodiment of the invention, at least one of the at least one capacitance in the identification data carrier is formed in such a manner that this defines the value of the resonant frequency of the resonant circuit structure which is specific for the object to be identified.

According to another exemplary embodiment of the invention, at least one of the at least one inductance in the identification data carrier is formed in such a manner that this defines the value of the resonant frequency of the resonant circuit structure which is specific for the object to be identified.

According to another exemplary embodiment of the invention, the identification data carrier is in the form of a radio frequency identification tag (RFID tag). In this case, the resonant circuit structure in the identification data carrier can be coupled to an integrated circuit on and/or in the substrate, in which case the integrated circuit can essentially be formed in the same way as in known RFID tags.

According to another exemplary embodiment of the invention, in an identification data carrier in the form of an RFID tag, information for customization of the RFID tag, or in other words identification information for the RFID tag, can be stored in the tag by means of a programming method at wafer level (on-wafer programming), after manufacture of the tag.

According to another exemplary embodiment, a plurality of bits are coded by the resonant circuit structure of the identification data carrier by fine adjustment (tuning) of the resonant frequency of the resonant circuit by matching of the coupling capacitor and/or of the coupling coil in the resonant circuit. According to one exemplary embodiment of the invention, the bit content can be coded by means of a discrete resonant frequency or by means of a frequency range.

In other words, according to one exemplary embodiment of the invention, the resonant frequency which is used to code the object-specific information can be defined or set such that the at least one capacitance and/or the at least one inductance, to be more precise the corresponding values of the at least one capacitance and/or of the at least one inductance, in the identification data carrier can be appropriately matched.

A resonant circuit structure in which a capacitance C (for example in the form of a capacitor), an inductance L (for example in the form of a coil) and a resistance R are connected in series clearly forms an electromagnetic series resonant circuit whose resonant frequency f is given by:

$$f = \frac{1}{2 π \sqrt{LC}} \qquad ( 1 )$$

As can be seen from equation (1), the resonant frequency f depends both on the inductance L and on the capacitance C of the resonant circuit or of the resonant circuit structure of the identification data carrier. In other words, the resonant frequency f of the resonant circuit or of the resonant circuit structure is a function of L and C and can thus be influenced or set as appropriate by matching of L and/or C.

Following the principle described above, it is possible according to one exemplary embodiment of the invention for different data contents, for example object-specific information, to be represented, or in other words coded, by different resonant frequencies or else by different frequency ranges (frequency intervals).

According to one exemplary embodiment of the invention, a first information item I₁ can be coded by a first resonant frequency f₁, a second (not the same as I) information item I₂ can be coded by a second resonant frequency f₂ (f₂≠f₁), a third (not the same as I₁ or I₂) information item I₃ can be coded by a third resonant frequency f₃ (f₃≠f₁ [symbol] f₃≠f₂), etc.

According to one alternative exemplary embodiment of the invention, the first information item I₁ can be represented by a first frequency range [f₁−Δf₁, f₁+Δf₁], the second information item I₂ can be represented by a second frequency range [f₂−Δf₂, f₂+Δf₂], the third information item I₃ can be represented by a third frequency range [f₃−Δf₃, f₃+Δf₃], etc. In this case, care must be taken to ensure that the individual frequency ranges which code the information items I₁, I₂, I₃ etc. do not overlap one another, in order to allow a unique association between a frequency range and the information coded by this frequency range.

According to another exemplary embodiment of the invention, the at least one capacitance in the identification data carrier has a plurality of partial capacitances connected in parallel with one another.

Individual bits of the information can be coded by the presence or absence of specific partial capacitances with specific predetermined capacitance values.

According to one exemplary embodiment of the invention, a resonant circuit structure or a transponder in an identification data carrier may have a series circuit comprising a resistance R, an inductance with the value L as well as n (n ∈ N) parallel-connected partial capacitances with the values C₁, C₂, C₃, . . . , Cn. The total capacitance or equivalent capacitance of the parallel-connected partial capacitances in the resonant circuit of the resonant circuit structure is then equal to the sum of the individual partial capacitances, that is to say:

$$C = {\sum }_{k = 1}^{n} {C}_{k} = {C}_{1} + {C}_{2} + {C}_{3} + … + {C}_{n} . \qquad ( 2 )$$

The total capacitance C of the resonant circuit structure can be matched or varied in accordance with equation (2) for a given value L of the inductance, in order to obtain a specific resonant frequency f in accordance with equation (1), for coding of a specific information item. The individual bits of information can be coded such that each bit in the information is associated with one, and only one, partial capacitance in the resonant circuit structure. In other words, if the information length is n bits, the k-th partial capacitance in the resonant circuit structure with the value Cₖ can be associated with the k-th information bit, where 1≦k≦n.

It is then possible to code bits by a partial capacitance (or a capacitor which forms the partial capacitance) which corresponds to a specific bit being present (for example representing a logic “1”) or missing (for example representing a logic “0”) in the resonant circuit structure.

In other words, according to one exemplary embodiment of the invention, object-specific information which may comprise a total of up to n bits can be coded with the aid of a resonant circuit structure which has parallel-connected partial capacitances by specific partial capacitances in the total of n partial capacitances with the values C₁, C₂, C₃, . . . , Cₙ either being present (there) or missing. The value C of the total capacitance can thus be defined in accordance with equation (2), and the resonant frequency f of the resonant circuit structure can thus be defined in accordance with equation (1) for a given value L of the inductance.

According to another exemplary embodiment of the invention, the resonant circuit structure in the identification data carrier has at least one protective device which is connected in series with at least one partial capacitance. A partial capacitance which is connected in series with the protective device can be activated or deactivated by a protective device.

According to another exemplary embodiment of the invention, one or more of the at least one protective device may for example, be in the form of a fuse-link device (also referred to as a fuse), and may be used for activation of the corresponding series-connected partial capacitance/s. Alternatively, according to another exemplary embodiment of the invention, one or more of the at least one protective device may be in the form of an anti-fuse-link device (also referred to as an anti-fuse), and may be used for deactivation of the corresponding series-connected partial capacitance/s.

According to another exemplary embodiment of the invention, the at least one protective device may be configured such that a different material state is produced or triggered (in the protective device) by the supply of energy, and is expressed by a change in the electrical resistance of the material (of the protective device). A series-connected partial capacitance can be correspondingly activated or deactivated depending on whether the resistance of the material changes from a high value to a lower value, or vice versa.

According to another exemplary embodiment of the invention, a low-cost identification data carrier is produced by means of which a sufficiently large amount of information can be transferred.

According to another exemplary embodiment of the invention, a method based on frequency modulation is provided for coding an information in an identification data carrier. According to another exemplary embodiment of the invention, a method is provided which, for example, is more suitable than a method based on amplitude modulation for use from a relatively long distance (remote use): in the case of a method based on amplitude modulation, blank data must be sent first of all before the identification data carrier is actually read, in order to tune the read amplitude range of the read apparatus, in order to ensure adequate robustness during reading and evaluation of the data. There is no need for this for the described method, which is based on frequency modulation, according to the exemplary embodiment, since, in the case of frequency modulation, the reliability during data reading is higher than in the case of amplitude modulation.

According to another exemplary embodiment of the invention, an identification data carrier is provided which requires only one resonant circuit structure or antenna. The identification data carrier is thus, for example, more efficient in terms of area utilization than an identification data carrier having a plurality of resonant circuit structures.

According to another exemplary embodiment of the invention, in contrast to a conventional complex RFID tag, the production of an identification data carrier is not restricted to CMOS process technology (complementary metal oxide semiconductor). For example, according to one exemplary embodiment of the invention, all materials which have a response that is typical of a resonant circuit may be used for production of the identification data carrier.

According to another exemplary embodiment of the invention, an identification data carrier is provided which has a substrate as well as a resonant circuit structure, which is formed on or in the substrate, for an electromagnetic resonant circuit, with the resonant circuit structure being formed in such a manner that it has a resonant frequency whose value is specific for an object to be identified.

Exemplary embodiments of the invention are illustrated in the figures and will be explained in more detail in the following text. To the extent that this is worthwhile, identical or similar elements in the figures are provided with the same or identical reference symbols. The illustrations shown in the figures are schematic, and are therefore not drawn to scale.

FIG. 1 shows an identification system 100 according to one exemplary embodiment of the invention having a first identification data carrier 102a, a second identification data carrier 102b, and a third identification data carrier 102c as well as a read apparatus 105 for reading object-specific information which is contained in the first identification data carrier 102a, in the second identification data carrier 102b and in the third identification data carrier 102c.

The first identification data carrier 102a, the second identification data carrier 102b and the third identification data carrier 102c each have a substrate 103 which, for example, may be in the form of a plastic carrier or a package of an object to be identified, or else may be in the form of the object to be identified, itself. The first identification data carrier 102a has a first resonant circuit structure 104a for a first resonant circuit with a first resonant frequency f₁ which is specific for a first object. The second identification data carrier 102b has a second resonant circuit structure 104b for a second resonant circuit with a second resonant frequency f₂ which is specific for a second object. The third identification data carrier 102c has a third resonant circuit structure 104c for a third resonant circuit with a third resonant frequency f₃ which is specific for a third object.

The first object, the second object and the third object are different objects. The object-specific resonant frequencies f₁, f₂ and f₃ whose value codes the information about the respective object thus differ from one another in pairs, that is to say f₁≠f₂≠f₃≠f₁. The resonant circuit structures 104a, 104b and 104c may be formed on or in the respective substrate 103 of the corresponding identification data carrier 102a, 102b or 102c.

The read apparatus 105 formed in the identification system 100 has an electromagnetic radiation source 106 for emission of electromagnetic energy in a predeterminable frequency range or frequency interval I=(fₘᵢₙ, fₘₐₓ), as well as a detection device 107 for detection of the electromagnetic energy absorbed by the first resonant circuit structure 104a in the first identification data carrier 102a, by the second resonant circuit structure 104b in the second identification data carrier 102b, and by the third resonant circuit structure 104c in the third identification data carrier 102c at different frequencies in the predetermined frequency range, and for determination of the resonant frequencies of the resonant circuit structures 104a, 104b, 104c (that is to say the frequencies f₁, f₂ and f₃ in the illustrated example). The frequency range can be chosen such that fₘᵢₙ<{f₁, f₂, f₃}<fₘₐₓ in order to make it possible to ensure that the resonant frequencies f₁, f₂, f₃ of the resonant circuit structures 104a, 104b, 104c can be determined reliably by the detection device 107.

The read apparatus also has a determination device 108 for determination of the object-specific information which is contained in the identification data carriers 102a, 102b and 102c, from the respective value f₁, f₂ and f₃ of the resonant frequency of the corresponding resonant circuit structure 104a, 104b, 104c.

In other words, the object-specific information which is coded in the value of the resonant frequency is decoded again by means of the determination device 108.

This can be done, for example, by determining corresponding n-bit sequences B₁={b₁₁, b₁₂, . . . , b₁ₙ}, B₂={b₂₁, b₂₂, . . . , b₂ₙ} and B₃={b₃₁, b₃₂, . . . , b₃ₙ}, each comprising n bits (bⱼₖ ∈ {0,1} (1≦j≦3; 1≦k≦n), from the values f₁, f₂ and f₃ of the resonant frequencies of the corresponding resonant circuit structures 104a, 104b, 104c, which bit sequences contain or code the corresponding information about the respective object. In other words, the determination device 108 can be used to associate the resonant frequencies f₁, f₂ and f₃ with a corresponding bit sequence B₁, B₂ or B₃, for example by calculation on the basis of a predetermined algorithm, or by looking this up in a databank or an association table (lookup table), for example using an electronic data processing device (for example a computer).

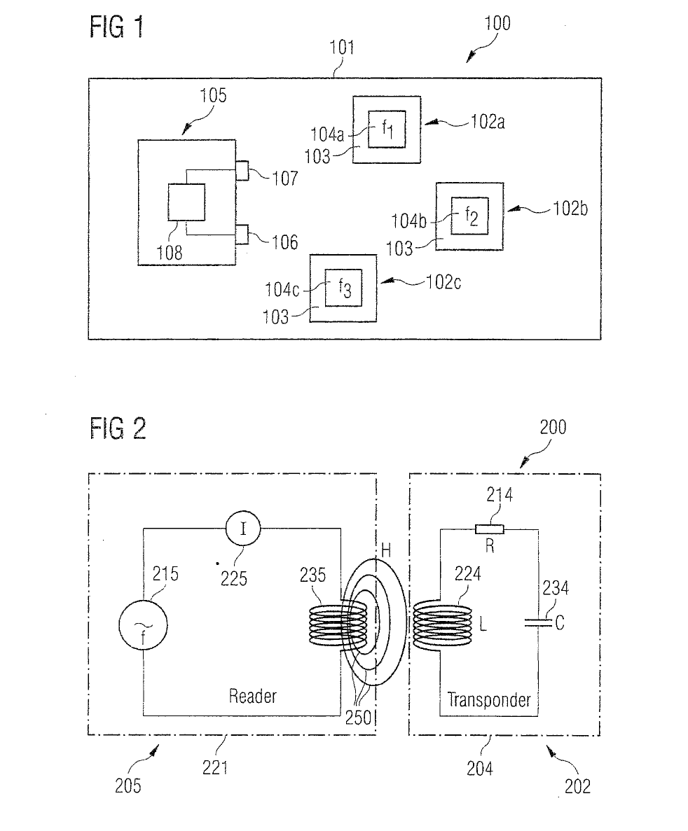

Although the electromagnetic radiation source 106, the detection device 107 and the determination device 108 of the read apparatus 105 are illustrated as being physically separate in FIG. 1, two or more of the components mentioned may be combined as one unit (see FIG. 2).

Furthermore, FIG. 1 shows the identification area 101 of the identification system 100, shown as the area around the read apparatus 105, in which an identification data carrier 102 can be reliably identified by the read apparatus, that is to say the range or detection range.

The exemplary embodiment of an identification system 100 illustrated in FIG. 1 has three identification data carriers 102a, 102b and 102c within the identification area 101. Alternatively, the identification system 100 may also have a different number of identification data carriers.

The process of reading an identification data carrier or the information contained in the identification data carrier will be explained in more detail in the following text with reference to FIG. 2.

FIG. 2 shows an identification system 200 according to another exemplary embodiment of the invention having an identification data carrier 202 which has a resonant circuit structure 204 (identified as a “transponder”) for an electromagnetic resonant circuit. The resonant circuit structure 204 of the identification data carrier 202 may be formed on or in a substrate (not shown). The electromagnetic resonant circuit of the resonant circuit structure 204 is in the form of an RLC series resonant circuit, having an electrical resistance 214, whose value is R, having an inductance 224, whose value is L, and having a capacitance 234 whose value is C. The capacitance 234 may, for example be formed by a capacitor, and the inductance 224 may, for example, be formed by an induction coil.

FIG. 2 also shows a read apparatus 205 (identified as a “reader”) which has an electromagnetic radiation source, a detection device and a determination device, with the electromagnetic radiation source, the detection device and the determination device being illustrated schematically by a common circuit 221 in FIG. 2. The circuit 221 has a signal generation device 215 (for example a function generator/frequency generator or a swept-frequency generator) for production of an alternating-current signal at a predeterminable frequency f. The signal generation device 215 is connected in series with a current level measurement device 225 (for example an ammeter) and an inductance 235 which, for example, is in the form of an (induction) coil.

An alternating-current signal is produced with the aid of the signal generation device 215 at a frequency f (for example in the radio-frequency range) in the circuit 221 and is emitted by means of the coil 235, which is connected in series with the signal generation device 215, as an electromagnetic wave at the frequency f and with the magnetic-field amplitude H into the surrounding area in order to read the object-specific information which is contained in the identification data carrier 202. The coil 235 acts, as can be seen, as an antenna for the read apparatus 205. The magnetic flux lines 250 of the electromagnetic wave emitted from the antenna are shown schematically in FIG. 2.

The electromagnetic wave is received by the identification data carrier 202, to be more precise by the resonant circuit structure 204 (transponder). As can be seen, the inductance 224 which is formed in the resonant circuit structure 204 likewise forms an antenna, and the magnetic flux lines 250 of the electromagnetic wave can pass through the turns of the inductance 224, which is in the form of an (inductance) coil, in the identification data carrier 202, and, by electromagnetic inductance can cause (induce) an alternating-current signal at the frequency f of the electromagnetic wave in the coil 224, and thus in the RLC series resonant circuit of the resonant circuit structure 204. The electromagnetic resonant circuit of the resonant circuit structure 204 in the identification data carrier 202 is thus stimulated to produce an electromagnetic oscillation at the frequency f, and itself emits a second electromagnetic wave via the inductance 224, which acts as an antenna, with this electromagnetic wave being superimposed on the electromagnetic wave that is emitted from the coil 235 in the read apparatus 205, and thus modulating it. The superimposition of the two waves results in a change (disturbance) in the magnetic field H of the electromagnetic wave which is emitted from the read apparatus 205. This disturbance can be detected by the read apparatus 205 by means of the coil 224, and leads to a change in or modification to the electric current I in the circuit 221 of the read apparatus 205, which current change can in turn be registered by the current level measurement device 225. Clearly, the coefficient of the mutual induction or mutual inductance is modified by the transponder (that is to say the resonant circuit structure 204) of the identification data carrier 202.

The read apparatus 205 receives, by back-scattering, the disturbance caused by the modulation in the magnetic field, which modifies the level of the electric current in the read apparatus 205. The disturbance in the magnetic field is a maximum when the frequency f of the signal which is transmitted from the read apparatus 205 is equal to the resonant frequency of the transponder, with this resonant frequency being given by the equation (1). According to equation (1), the resonant frequency of the transponder or of the resonant circuit in the resonant circuit structure 204 depends on the value L of the inductance 224 and on the value C of the capacitance 234. The value of the resonant frequency of the resonant circuit structure 204 can thus be defined by appropriate configuration of the capacitance 234 and/or of the inductance 224.

The production of electromagnetic signals (waves) at different frequencies, in other words with a spectrum of frequencies, for example in the course of a frequency sweep through a predeterminable frequency interval, and the detection of the electric current I induced in the circuit 221 (reader circuit) at the respective frequency make it possible to accurately determine the resonant frequency of the identification data carrier 202 (and possibly of other identification data carriers which are not shown) where this is located in the identification area (detection range, see FIG. 1) of the read apparatus 205. The current intensity of the induced current decreases as the distance between the read apparatus 205 and the transponder in the identification data carrier 202 increases, when the distance is greater than the radii of the coils 224 (transponder coil) and 235 (reader coil).

The read process, as described above in conjunction with FIG. 2, for one or more identification data carriers can be used to determine the resonant frequencies of the identification data carriers and the resonant frequencies of electromagnetic resonant circuits which are formed in the identification data carriers. This specific value of a resonant frequency in this case (uniquely) codes an information item which is specific for an object, such as the type or the price of an article in a department store. Different resonant frequencies thus code different information items.

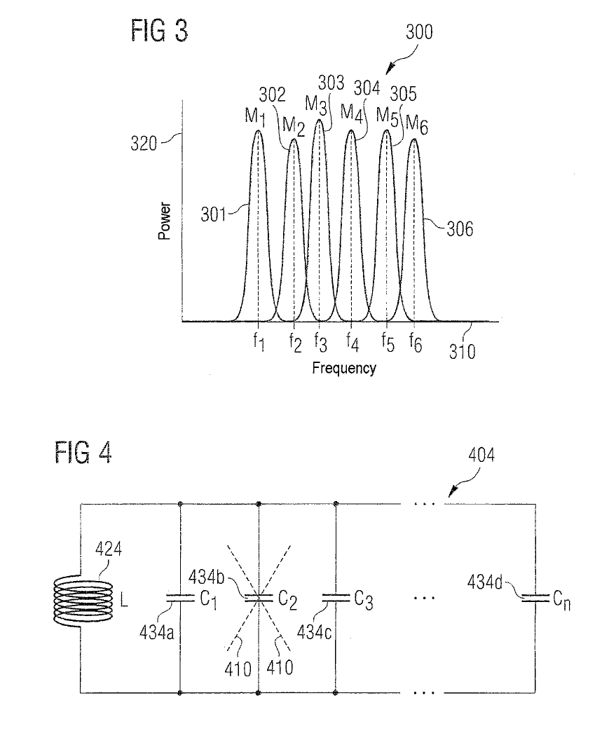

The graph 300 in FIG. 3, shows schematically and corresponding to one exemplary embodiment of the invention, the result of read processes and frequency scans on six different identification data carriers, which have six different resonant frequencies (f₁ to f₆). The frequency of the electromagnetic radiation emitted from a radiation source in a read apparatus is plotted on the abscissa 310 in the graph 300, while the electromagnetic power absorbed from the electromagnetic radiation by a resonant circuit structure in an identification data carrier at various frequencies in the frequency range is plotted on the ordinate 320. The graph 300 is therefore also referred to as a power absorption spectrum.

A first curve 303 represents the power absorbed by a resonant circuit structure in a first identification data carrier, with the absorption having a clearly pronounced maximum M₁. The resonant frequency f₁ of the resonant circuit structure in the first identification data carrier is obtained from the position, that is to say the associated frequency, of the first maximum M₁.

A second curve 304 represents the power absorbed by a resonant circuit structure in a second identification data carrier, with the absorption having a clearly pronounced maximum M₂, from whose position the resonant frequency f₂ of the resonant circuit structure in the second identification data carrier is obtained.

Correspondingly, the resonant frequencies f₃, f₄, f₅, f₆ of resonant circuit structures in a third, fourth, fifth and sixth identification data carrier are obtained in an analogous manner from absorption maxima M₃, M₄, M₅, M₆.

The values of the sixth resonant frequencies f₁, f₂, f₃, f₄, f₅, f₆ differ from one another in pairs, that is to say fᵢ≠fⱼ for i≠j, i,j ∈ {1,2,3,4,5,6}. Since an object-specific information item is uniquely coded by the value of a resonant frequency fᵢ, this means that the resonant circuit structures of the six identification data carriers each contain different object-specific information. For example, in a simple case, the sixth different frequency values can represent six different prices of an item on sale. The information coded by the value of the respective resonant frequency about the object to be identified can, however, also be considerably more complex and extensive.

As can be seen from FIG. 3, the absorption maxima M₁, M₂, M₃, M₄, M₅, M₆ have different intensities. This can be explained by the fact that the individual identification data carriers are at different distances from the read apparatus when being read by it, with the intensity of a maximum decreasing as the distance between the read apparatus and the transponder in the identification data carrier increases.

As already mentioned above, one or more capacitances and/or one or more inductances can be formed in one resonant circuit structure in an identification data carrier in such a way that, in accordance with equation (1), one specific value is defined for the resonant frequency of a resonant circuit, with specific information being coded by the value of the resonant frequency for an object. One example of a coding scheme will be explained in more detail in the following text with reference to FIG. 4.

FIG. 4 shows a resonant circuit structure 404 and a transponder in an identification data carrier according to one exemplary embodiment of the invention, which resonant circuit structure 404 has a series circuit comprising an inductance 424 with the value L as well as n (n ∈ N) parallel-connected partial capacitances with the values C₁, C₂, C₃ , . . . , Cₙ with FIG. 4 illustrating, for the sake of clarity, only a first partial capacitance 434a with a value C₁, a second partial capacitance 434b with the value C₂, a third partial capacitance 434c with the value C₃ and an n-th partial capacitance 434d with the value Cₙ.

The inductance 424 is in the form of an induction coil on a substrate, and the partial capacitances 434a, 434b, 434c, 434d (as well as the other partial capacitances which are not shown) being in the form of capacitors on the substrate. The series circuit of the resonant circuit structure 404 may also have one or more electrical resistances (not shown).

In the resonant circuit structure shown in FIG. 4, the value L of the inductance 424 is determined by the characteristics of the induction coil. In order to achieve a specific resonant frequency f in accordance with equation (1) for the resonant circuit structure 404 in order to code a specific information item, the total capacitance C of the resonant circuit structure 404 can thus be adapted and varied appropriately.

In order to simplify the automation of the production process for the identification data carriers, the individual bits of information can be coded as follows:
a first bit is associated with the first partial capacitance 434a in the resonant circuit structure 404, with the value C₁ of the first partial capacitance 434a being chosen to be C₁=2⁰C₀;
a second bit is associated with the second partial capacitance 434b in the resonant circuit structure 404, with the value C₂ of the second partial capacitance 434b being chosen to be C₂=2¹C₀;
a third bit is associated with the third partial capacitance 434c in the resonant circuit structure 404, with the value C₃ of the third partial capacitance C₃ being chosen to be C₃=2²C₀;
etc.

In general, a k-th (1≦k≦n) information bit is associated with the k-th partial capacitance in the resonant circuit structure 404, with the value Cₖ of the k-th partial capacitance being chosen to be Cₖ=2^{k-1}C₀. The factor C₀ is a predeterminable constant factor, clearly a predeterminable basic capacitance value. In the example, the value Cₖ of the k-th partial capacitance is therefore clearly a multiple, that is to say 2^{k-1} times, the predeterminable basic capacitance value C₀.

It is now possible to code individual bits either by the presence (for example representing a logic “1”) or the absence (for example representing a logic “0”) of a partial capacitance (or of the capacitor which forms the partial capacitance) corresponding to a specific bit.

In the example shown in FIG. 4, the second partial capacitance 434b with the value C₂ is not formed, as is illustrated by the dashed lines 410. Accordingly, the second bit, which corresponds to the second partial capacitance 434b, is coded as a logic “0” while, in contrast, for example, the first bit (represented by the first partial capacitance 434a), the third bit (represented by the third partial capacitance 434c) and the n-th bit (represented by the n-th partial capacitance 434d) are each coded as logic “1”, since the corresponding partial capacitances are present in the resonant circuit structure 404.

The total capacitance or equivalent capacitance C of the parallel-connected partial capacitances C₁ to Cₙ of the resonant circuit of the resonant circuit structure 404 is given by the sum of the individual partial capacitances C₁ to Cₙ.

In the example shown in FIG. 4, if it is assumed that, apart from the missing second partial capacitance 434b with the value C₂, all of the other partial capacitances are present, in other words that only the second bit is set to logic “0”, while all the other bits are set to logic “1”, then the value of the (equivalent) capacitance C is given by:
C=2⁰C₀+2²C₀+2³C₀+. . . +2ⁿ⁻¹C₀=(2ⁿ−3)C₀. (3)

Since the second partial capacitance 434b is not formed, the sum in equation (3) is missing the term 2¹C₀.

The resonant frequency f of the resonant circuit structure 404 is obtained by substitution of equation (3) in equation (1):

$$f = \frac{1}{2 π \sqrt{{LC}_{O} ( {2}^{n} - 3 )}} . \qquad ( 4 )$$

The resonant circuit structure 404 shown in FIG. 4 can therefore be used to code object-specific information with a length of n bits by individual partial capacitances in the total of n partial capacitances with the values C₁, C₂, C₃, . . . , Cₙ either being present (there) or missing. The value C of the total capacitance is defined in this way in accordance with equation (3), with each bit sequence giving a characteristic value C.

Equation (1) is then used to obtain the value of the resonant frequency f of the resonant circuit structure 404 for a given value L of the inductance 424, with each bit sequence once again yielding a characteristic resonant frequency value.

Conversely (if the value L of the inductance is known), the value C of the total capacitance can be calculated from the resonant frequency f determined by reading the identification data carrier, by solving the equation (4) or the equation (1), and the bits which are present and the bits which are absent can be deduced uniquely from this using equation (3), thus decoding the information contained in the identification data carrier.

In order to allow greater flexibility during the production process, the type of coding described with reference to FIG. 4 can on the one hand be implemented by physically forming individual capacitors which represent the partial capacitances C₁ to Cₙ, and thus the n bits, on the substrate of the identification data carrier, and by these being connected to the antenna of the transponder (that is to say of the coil) corresponding to the presence or absence of a bit. On the other hand, the coding can be achieved by forming an individual capacitor on the substrate, with the individual capacitor having a capacitance value which corresponds to the total capacitance of the individual bits. In other words, the individual capacitor has a capacitance C whose value is given by the left-hand side in equation (2) or equation (3).

If the individual bits are coded by the formation of individual partial capacitances, only the partial capacitances which are required for coding can be formed during the production of the identification data carrier.

Alternatively, all of the partial capacitances (capacitors) can initially be formed during the production, and then individual partial capacitances (and thus bits) can be selectively activated or deactivated. For example, a fuse-link device (fuse) can in each case be connected in series with one or more of the partial capacitances C₁ to Cₙ shown in FIG. 4, and the partial capacitances connected in series with the fuses can be deactivated by irreversibly burning through or melting through individual fuse-link devices or fuses when a voltage is applied.

Alternatively, to one or more of the partial capacitances C₁ to Cₙ shown in FIG. 4, an anti-fuse link device (anti-fuse) can in each case be connected in series, and the isolation layer of these anti-fuses can be irreversibly burnt through by application of a voltage to selected anti-fuses, thus resulting in a low-impedance connection and in the activation of the corresponding series-connected partial capacitances.

It has to be pointed out that one or more identification data carriers can be applied to a package of an object to be identified, or to an object to be identified itself. If, for example, a plurality of identification data carriers are applied to a package of an object to be identified or to an object to be identified itself, the object can be identified by an identification data carrier having a first resonant frequency and, for example, the price or some other characteristic of the object can be identified by a different identification data carrier having a second resonant frequency, etc.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are intended to be embraced.

1. An identification data carrier, comprising:
a substrate;
a resonant circuit structure, which is formed on or in the substrate, for an electromagnetic resonant circuit which has a resonant frequency which is specific for an object to be identified.

2. The identification data carrier as claimed in claim 1, wherein the substrate is a plastic carrier.

3. The identification data carrier as claimed in claim 1,
wherein the substrate is the packaging of the object to be identified.

4. The identification data carrier as claimed in claim 1,
wherein the resonant circuit structure comprises at least one capacitance and at least one inductance.

5. The identification data carrier as claimed in claim 4,
wherein the at least one capacitance is connected in series with the at least one inductance.

6. The identification data carrier as claimed in claim 4,
wherein the at least one capacitance is formed in such a manner that it defines the value of the resonant frequency, which is specific for the object to be identified, of the resonant circuit structure.

7. The identification data carrier as claimed in claim 4,
wherein the at least one inductance is formed in such a manner that it defines the value of the resonant frequency, which is specific for the object to be identified, of the resonant circuit structure.

8. The identification data carrier as claimed in claim 4,
wherein the at least one capacitance comprises a plurality of parallel-connected partial capacitances.

9. The identification data carrier as claimed in claim 8,
wherein the resonant circuit structure comprises at least one protective device, which is connected in series with at least one partial capacitance, wherein the at least one partial capacitance which is connected in series with the at least one protective device can be activated or deactivated with the aid of the at least one protective device.

10. The identification data carrier as claimed in claim 4,
wherein the at least one capacitance is a capacitor.

11. The identification data carrier as claimed in claim 4,
wherein the at least one inductance is an induction coil.

12. The identification data carrier as claimed in claim 1,
wherein the identification data carrier is an RFID tag.

13. An identification data carrier, comprising:
a substrate;
a resonant circuit structure, which is formed on or in the substrate, for an electromagnetic resonant circuit, wherein the resonant circuit structure is designed in such a manner that it has a resonant frequency whose value is specific for an object to be identified.

14. A read apparatus for reading object-specific information which is contained in an identification data carrier, comprising:
an electromagnetic radiation source for emission of electromagnetic energy in a predeterminable frequency range;
a detection device for detection of the electromagnetic energy which is absorbed by a resonant circuit structure of the identification data carrier at different frequencies in the frequency range, and for determination of the value of the resonant frequency of the resonant circuit structure;
a determination device for determination of the object-specific information which is contained in the identification data carrier, from the value of the resonant frequency of the resonant circuit structure.

15. An identification system, comprising:
at least one identification data carrier as claimed in claim 1;
a read apparatus as claimed in claim 14 for reading object-specific information which is contained in the at least one identification data carrier.

16. A method for producing an identification data carrier, comprising:
forming a resonant circuit structure for an electromagnetic resonant circuit on a substrate,
wherein the resonant circuit structure is formed in such a manner that it has a resonant frequency which is specific for an object to be identified.
